(19) United States
(12) Patent Application Publication
(10) Pub. No.: US 2012/0114828 A1
(43) Pub. Date: May 10, 2012

(54) POST FERMENTING OPTIMIZER (PFO) FOR THE PREPARATION OF BEER

(75) Inventors: Patrick Accristo, Grasse (FR); Michel Aubanel, Grasse (FR); Cyril Denis, Cannes (FR); Dave Mawby, Cheshire (GB); Matthew Servini, Hettfordshire (GB); Nilabh Singh, Mysore (IN); John Terry, Manchester (GB)

(73) Assignee: CARGILL INCORPORATED, Wayzata, MN (US)

(21) Appl. No.: 13/123,437

(22) PCT Filed: Oct. 13, 2008
(86) PCT No.: PCT/EP2008/008654

§ 371 Date: Aug. 2, 2011

(51) Int. Cl. C12C 1/18; C12C 11/11; C12C 5/02

(52) U.S. Cl. 426/592; 426/436; 426/618

(57) ABSTRACT

The present application relates to a method of preparing a beer or beer-like beverage by adding a Post Fermenting Optimizer (PFO) in form of an infusion of roasted malt or a distillate thereof after fermentation. This addition of PFO provides the beer or beer-like beverage with additional body, base flavour and/or top notes. The present invention relates also to the PFO infusion itself, its distillate, the methods for preparing them and their use for reducing staling during beer or beer-type product shelf-life.

The present invention relates to the preparation of beer or a beer-like beverage. In particular, the present invention relates to a method of preparing a beer or beer-like beverage by adding a Post Fermenting Optimizer (PFO) in form of an infusion of roasted malt or a distillate thereof during preparation in order to provide the beer or beer-like beverage with additional body, base flavour and/or top notes. Further aspects of the present invention are directed to the PFO infusion itself, its distillate and the methods for preparing them.

Beer brewing is an ancient art; its origins trace back to at least the fourth millennium B.C. The brewing process consists essentially of two parts: the malting step and the fermentation step. In general, beer can be defined as an alcoholic beverage prepared by fermentation of starch-based raw materials. Its basic ingredients malt, usually prepared from barley and/or wheat, hop, brewer's yeast and water have not changed over the centuries.

In view of its long tradition and large popularity in numerous cultural areas of the world, it is not surprising that countless attempts have been made to diversify and tailor the flavour of this alcoholic beverage. However, many consumers today attach great importance to the fact that the beer they drink is made from a restricted number of natural constituents without additional adjuncts.

In the beer industry, the use of extracts of its main constituents is so far largely restricted to the use of hop extracts for tailoring the flavour of the beverage, see e.g. EP 0 975 736 or U.S. Pat. No. 6,242,038. This addition of hop extracts or hop essences can partially or fully substitute for the use of natural hop in providing the typical bitter hop flavour characteristic of beers. The hop extracts are also used to reduce the amount of storage room, cooling and transport necessary for the hop and the costs associated therewith. When substituted completely, liquid hop extracts further allow to avoid the use of a hopback during the brewing process.

In contrast, the use of malt extracts is less common. So far, the industrial use of malt extracts is largely restricted to the preparation of low- or non-alcoholic beverages, for example in U.S. Pat. No. 4,721,621, but the malt extract described therein is added before fermentation and helps the manufacturer to control said fermentation.

In beer production, malt extract has been described as an agent for the reduction of gushing and of fermentation time. U.S. Pat. No. 4,339,466 describes a process for extracting ground malt with a solution containing in excess of 75% of ethanol and concentrating said ethanol extract to yield an antifoaming agent. This antifoaming agent is added to reduce the foaming during the fermentation of beer wort. According to this disclosure, the use of that extract further enables reducing the time necessary for the fermentation process.

Recently, the prices for crops such as wheat and/or barley increased considerably. As barley and the malt prepared thereof is a central ingredient of all types of beer, this development has also great impact on the beer brewing industry. Therefore, there is also a need to develop methods which would allow to reduce the quantity of barley malt for producing beer without compromising its taste.

Thus, the present invention is directed to the use of a malt infusion or a distillate thereof in the preparation of a beer or a beer-like beverage in order to provide the beer or beer-like beverage with additional body, base flavour and/or top notes.

In the first aspect, the present invention is directed to the preparation of a malt infusion, wherein roasted malt is extracted with an aqueous solvent solution. Said aqueous solvent solution can be a mixture of food-grade solvent, such as food-grade ethanol, and water and contains up to 60% by volume of solvent. In a preferred embodiment, the aqueous solvent solution comprises from 20 to 40% by volume or, even more preferably, from about 25 to 35% by volume, such as about 30% by volume of solvent.

In general, the malt used is the same malt as used in the preparation of the type of beer the infusion is destined to be added to. As most beers are prepared from barley, the roasted malt is usually a barley malt. However, it can also be a roasted wheat or roasted sorghum malt and mixtures of those with or without barley malt. The term malt as used herein is also intended to encompass roasted barley, sorghum or wheat when used before germination.

Usually, the roasted malt used to prepare a malt infusion can be prepared by purifying the crude crops, steeping the purified grains in water, allowing the steeped grain to germinate and drying the germinated grain in a kiln. Subsequently, the thus prepared dried malt is roasted, typically at a temperature of about 120 to 230° C. The malt roasting process is well known in the art. According to the present invention, the roasting of malt is used for tailoring the flavour of beer and, optionally, the colour, particularly in the preparation of dark beers. Any kind of roasted barley, wheat and/or sorghum malt can be used and the temperature and time of roasting may vary, depending on the flavour to be achieved in the final beverage. For example, a weakly roasted malt having 200 EBC units (also referred to as °EBC or “Cara” units, EBC=European Brewery Convention) or less could be used. In a preferred embodiment, the weakly roasted malt is roasted to about 120 EBC. Alternatively, dark roasted malt with 1000 EBC or more can be used. Typically, the roasted malt, such as roasted barley malt, used in the present invention has from about 100 to about 1500 EBC units.

The roasted malt is then milled. The person skilled in the art is well aware how to mill a roasted malt, and any type of mill known in the art can be used, e.g. a tolling mill.

The thus obtained milled roasted malt is ready for the extraction with an aqueous solvent solution according to the present invention. Usually, the extraction is carried out at a temperature above room temperature, such as between 30° C. and a temperature below the boiling point of the aqueous solvent solution. In a preferred embodiment, the extraction of the milled roasted malt is carried out at a temperature of between about 50° C. and 65° C., such as about 50° C., about 55° C., about 60° C. or about 65° C. The aqueous solvent solution used for the extraction can be heated to the desired temperature during the extraction, or, alternatively, the extraction solution is heated to the desired temperature before its addition to the roasted malt. In a preferred embodiment, the extraction solution is recirculated during the extraction process and/or agitated with a stirrer.

The aqueous solvent solution according to the present invention is a mixture of water and any solvent suitable for extraction of edible products. In a preferred embodiment, the solvent to be combined with water is chosen from the group consisting of propane, butane, ethyl acetate, ethanol, carbon dioxide, hexane, ethylmethylketone, dichloromethane, methanol, 1,1,1,2-tetrafluoroethane, isopropanol, methylene chloride and mixtures thereof. In a highly preferred embodiment the solvent used is ethanol, isopropanol, methylene chloride, or hexane and mixtures thereof. In an even more preferred embodiment the solvent is ethanol, typically food-grade ethanol. The term “solution” as used herein includes also mixtures of constituents that are only partially soluble with each other, which may form emulsion-type mixtures.

In an embodiment, a subsequent solvent may be added (after extraction) to the extract or infusion for preserving its taste. Said subsequent solvent is preferably propylene glycol or triacetine and mixtures thereof.

The extraction can be performed just once or, according to a preferred embodiment, repeatedly by removing and collecting the extraction solution after a predetermined amount of time and replenishing the extraction vessel with fresh aqueous solvent solution. Such a stepwise extraction with refreshing the aqueous solvent solution after a predetermined time can be performed several times such as twice, three times or more often.

In another embodiment the same aqueous solvent solution may be used for a multiple extraction step. This will allow an improvement of the taste intensity and extraction yield of the final extracts.

Alternatively, the extraction can also be performed continuously by feeding fresh aqueous solvent solution and channelling away and collecting a certain part of the used aqueous solvent extraction solution continuously or in intervals. Of course, such a continuous extraction process can also be combined with a stepwise (multiple) extraction.

The extraction process should be performed for a sufficient amount of time to allow for an efficient extraction of the desired malt constituents. Typically, the extraction is performed for about 3 to about 24 hours. For example, the extraction can be performed in 3 to 5 steps of 2 to 5 hours of extraction each with replenishing the aqueous solvent solution after each individual extraction step and collecting the used extracting solutions.

Typically, the amount of aqueous solvent solution simultaneously in contact with the roasted barley malt is limited. Good results can be obtained if the weight ratio of the aqueous solvent solution used in one extraction step to the milled roasted malt is between about 1:2 and 20:1, such as, e.g., 1:1, 2:1, 3:1 or 5:1.

After the extraction or after the final extraction step, all aqueous solvent solution used for extracting is gathered in a dedicated tank. This collected solution is the malt infusion obtained according to one aspect of the present invention.

In a preferred embodiment, a maturation step occurs on the malt infusion; this allows a natural sedimentation in order to separate the powder that might be contained in the infusion. Typically, a filtration step is then used to remove the insolubles. The maturation occurs preferably in the tank where the infusion is left for a few days, especially about five days. It has to be noted that a physical separation of the insolubles could be done by, for example, ultra-filtration but this could have a negative effect on the flavour profile. The filtration is known by the skilled person and is preferably done using a 1 μm mesh sieve.

Thus, one aspect of the present invention is directed to an infusion of roasted malt in an aqueous solvent solution, which is obtainable according to a method as described above. In a preferred embodiment, the infusion of roasted malt, such as roasted barley, sorghum and or wheat malt, has a dry weight from about 3 to about 10% by weight, more preferably from about 4, 5 to about 7% by weight. “Dry weight” as used in the present invention is the amount of liquid, oily or solid residuals of the infusion (or a distillate), removed quantitatively from solvent and water.

The solvent content of the infusion largely corresponds to the solvent content of the aqueous solvent solution used in the extraction process. Thus, the solvent content of the roasted malt infusion is up to about 60% by volume, and according to a preferred embodiment, the solvent content of the infusion is between about 20 and 40% by volume, more preferably between about 25 to 35% by volume. For example, if the amount of alcohol as a solvent is about 30% by volume in the aqueous solvent solution to be used for the extraction, the resulting roasted malt infusion will usually have an alcoholic degree between about 28 and 32% by volume.

According to a further aspect of the present invention, the thus obtained infusion of roasted malt in aqueous solvent solution is subsequently distilled. Typically, the distillation is performed in a still under atmospheric pressure.

According to a preferred embodiment, the distillation process is performed until the collected distillate shows a concentration of solvent between about 20 and 40% by volume, more preferably between about 25 to 35% by volume. The distillation should be performed at a temperature from about 80° C. to about 100° C. to ensure the quality of the obtained distillate and to avoid the loss of valuable constituents, e.g. by decomposition. The thus obtained distillate is usually a clear limpid liquid. It is particularly feasible to provide beer with a desirable body and flavours. However, if just a particular fraction of the obtainable distillate is desired, e.g., the solution obtained after a single extraction could also be separated or the distillation could be stopped earlier, depending to the particular circumstances. If necessary, the distillate could also be readjusted to a solvent content of about 25 to 35% by volume by the addition of solvent (food-grade) or water.

As mentioned above, the infusion of roasted malt or the distillate of said roasted malt infusion could be used to add flavour and body to a beer or beer-like beverage. Beer or beer-like beverages as used herein encompass beverages obtained from a cereal solution such as beer, ale, stout, lager, porter, low alcoholic beer, alcohol-free beer, kvass, rye-bread beer, shandy, malt drinks and the like.

As used herein, the “body” of a beer or beer-like beverage is distinguished from the taste and flavour. It is primarily determined by the mouthfeel sensations, which are dependant on the overall texture of the beverage and its physical and chemical interactions in the mouth. Since most beverages are very low in viscosity and have no measurable yield stress, the mouthfeel and body attributes of these beverages should be related to other forces than viscosity in the mouth, such as lubrication, that lead to the sensations of mouthfeel and body in these products. These properties can be best examined by test panels or the use of a tribology device as described in PCT/EP2008/004443.

For example, calorie-reduced or light beers are known to be distinguished by consumers from full beers with respect to their body and mouthfeel attributes, a fact which is well known in the beer industry. This often leads to a reduced level of acceptance. Therefore, a particularly desirable use of the infusion or the distillate of the present invention is the possibility to add body to a calorie-reduced beer and raise the overall acceptance of such a beer.

Another aspect of the present invention is thus the provision of a beer or beer-like beverage. The beer or beer-like beverage according to the invention can be produced analogously to conventional brewing processes known in the art, except for the addition of the infusion or the distillate after the step of yeast fermentation. The infusion of roasted barley malt and/or a distillate thereof can be added directly into the fermented brew, or it can be added after the brew was filtered to remove the yeast, if such a filtering step is intended in the production process of the final beer. After the addition of the malt infusion or its distillate, the obtained liquid (or yeast suspension) is thoroughly mixed. Optionally, the obtained mixture can now be filtered to remove the yeast or other particulate, if this is deemed appropriate. The resulting mixture is then further processed, e.g. it can be filled into bottles or kegs and stored, resulting in a marketable beer or beer-like beverage according to the present invention.

In a particularly preferred embodiment, the fermented liquid (or yeast suspension) is prepared as normally brewed beer, however, with a reduced amount of malt per volume of beer being used. Such beers having a reduced amount of malt are known in the art and are used, e.g. as a basis for light beers or calorie-reduced beers. However, with the use of a reduced amount of malt, the resulting product is typically associated with a reduced body, reduced base flavour and reduced top notes derived from the malt. If, for example, a full beer is brewed and then diluted with water, not only the caloric content of the beer is reduced, but also some of its body and flavour is lost.

To make up for the reduced body, base flavour and top notes, the present invention teaches to add the infusion of roasted malt in aqueous solvent solution or the distillate thereof, thereby providing the finally obtained beer or beer-like beverage with additional body, base flavour and/or top notes. Thus, the present method of preparing a beer or beer-like beverage allows to use a reduced amount of malt during the beer brewing process as compared to the amount typically used in the preparation of a full beer without having to accept a loss in body, base flavour and top notes. The obtained malt infusion or the distillate thereof contain substances capable of providing a beer with body and flavours, such as flavour congeners soluble primarily in solvent or solvent-enriched liquid, in a concentrated form, i.e., these substances are present in the infusion or the distillate thereof in a higher amount per unit weight of malt used than they are present in a normally produced beer. Therefore, a beer or beer-like beverage containing the roasted malt infusion or its distillate requires considerably less malt than necessary for preparing a full beer according to the prior art. In consequence, the addition of the infusion or the distillate thereof according to the invention allows for a reduction of the net amount of malt necessary to prepare the beer or beer-like beverage without losing taste and body.

Thus, the use of the infusion of roasted malt or the distillate thereof allows for a reduction of the costs necessary for the crops, and furthermore, it can also simplify the brewer supply chain. An additional advantage of the present invention is the reduction of staling effect that often happen on traditional beers; indeed, flavors profiles of beer usually change during shelf-life of the product; the present PFO avoid this phenomenon. A further advantage of the invention is the masking of off-taste that can appear during shelf-life or processing. In fact the PFO according to the present invention are useful for standardizing taste of beer by masking any variation that can occur due to small process modification or due to the fact that the malt traditionally used is a natural product and has some various characteristics.

The thus obtained beer according to the invention not only has the top notes and the body and base flavour of full beer, but it is also a natural product according to the requirements of the European Union Natural Labelling Council Directive 88/388 EEC. Moreover, the beer preparation method according to the present invention also complies with many consumers' desire to have a beer without additional adjuncts, but which is produced only from the core ingredients barley, sorghum and/or wheat, hop, yeast, solvent and water.

The present invention is further illustrated by the examples provided below. It is understood that these examples are not intended to limit the scope of the present invention in any way.

### EXAMPLES

The extraction solution used in the present examples is a food grade solution. For example when ethanol is used, a 96% ethanol solution is used (4% of water inside).

### Example 1

400 kg barley malt grain, weakly roasted to 120 EBC units (Cara120 EBC), milled by a tolling mill, was filled into an extractor basket provided in an extraction apparatus. Then, the extractor was charged with 1500 liter of aqueous ethanol solution containing 31% by volume of ethanol. The solution was heated to 60° C. under stirring and kept in contact with the milled malt for at least 3 hours under recirculation. Thereafter, the solution was discharged into a cleaned tank and 800 liter of fresh extraction solution (31% vol. EtOH) was fed into the extractor. The extractor was heated again to 60° C. and kept for another at least 3 hours at 60° C. under recirculation before discharging the extraction solution. This procedure of feeding 800 liter of fresh extraction solution, keeping the solution at 60° C. under recirculation for 3 hours and discharging was repeated two more times. The discharged extraction solutions (˜2900 liter) were combined and, after 5 days of maturation, filtered through a 1 μm mesh sieve.

The obtained product had an alcohol content of about 30% by volume and a dry weight of 5 to 6%.

### Example 2

400 kg barley malt grain, roasted to 1000 EBC units (Cara1000 EBC), milled by a tolling mill, was filled into an extractor basket provided in an extraction apparatus. Then, the extractor was charged with about 800 liter of aqueous ethanol solution containing 31% by volume of ethanol. The solution was heated to 60° C. under stirring and kept in contact with the milled malt for at least 2 hours under recirculation. Thereafter, the solution was discharged into a cleaned tank, and the procedure of feeding 800 liter of fresh extraction solution (31% vol. EtOH), keeping the solution at 60° C. under recirculation for 2 hours and discharging was repeated three more times, except for the last extraction step wherein only the minimal amount of solution to cover the barley grain was used. The discharged extraction solutions (˜2900 liter) were combined and, after 5 days of maturation, filtered through a 1 μm mesh sieve.

The obtained product had an alcohol content of about 30% by volume and a dry weight of 5 to 6%.

### Example 3

600 kg of the weakly roasted malt infusion produced in example 1 was filled into a 1200 liter distillation apparatus and heated under atmospheric pressure. The distillation was continued until the recovered distillate had an alcoholic content of 30% by volume. The distillate was mixed and a 250 ml sample was taken and analyzed for its alcoholic content.

The thus obtained distillate of a weakly roasted malt infusion was a clear limpid product with an alcohol content of about 30% by volume.

### Example 4

600 kg of the roasted malt infusion produced in example 2 was filled into a 1200 liter distillation apparatus and heated under atmospheric pressure. The distillation was continued until the recovered distillate had an alcoholic content of 30% by volume. The distillate was mixed and a 250 ml sample was taken and analyzed for its alcoholic content.

The thus obtained distillate of a roasted malt infusion was a clear limpid product with an alcohol content of about 35% by volume.

1. A method of preparing a malt infusion, comprising extracting roasted malt is extracted with an aqueous solvent solution of up to about 60% by volume of solvent.

2. The method of preparing a malt infusion according to claim 1, wherein the roasted malt is a roasted barley, sorghum or wheat malt and mixtures thereof.

3. The method of preparing a malt infusion according to claim 1, wherein the aqueous solvent solution comprises from about 20% to about 40% by volume of solvent.

4. The method of preparing a malt infusion according to claim 1, wherein the extraction is carried out at a temperature between 30° C. and the boiling point of the aqueous solvent solution.

5. The method of preparing a malt infusion according to claim 1, wherein the extraction is carried out by replacing the aqueous solvent solution with fresh aqueous solvent solution repeatedly or continuously, and collecting the used aqueous solvent solution.

6. An infusion of roasted malt in an aqueous solvent solution obtainable by a method according to claim 1.

7. The infusion of roasted malt in an aqueous solvent solution according to claim 6, wherein the dry weight of said infusion is from about 3% to about 10% by weight, preferably from 4,5 to 7% by weight.

8. A distillate of a roasted malt infusion obtainable by distilling the infusion of roasted malt in an aqueous solvent solution according to claim 6, wherein said distillate has a dry weight of about 3% to about 10% by weight.

9-11. (canceled)

12. A method of preparing a beer or beer-like beverage, wherein the infusion according to claim 6 is added is after yeast fermentation for providing said beer or beer-like beverage with additional body, base flavour and/or top notes.

13. The method of preparing a beer or beer-like beverage according to claim 12 for reducing the amount of malt during the brewing process while providing said beer or beer-like beverage with the body and base flavour of full beer.

14. A method for reducing staling during beer or beer-type product shelf-life comprising adding the infusion of claim 6 to beer or a beer like beverage.

15. The method of preparing a malt infusion according to claim 1, wherein the aqueous solvent solution comprises from about 25% to about 35% by volume of solvent.

16. The method of preparing a malt infusion according to claim 1, wherein the extraction is carried out at a temperature between about 50° C. and about 65° C.

17. The infusion of roasted malt in an aqueous solvent solution according to claim 6, wherein the dry weight of said infusion is from about 4.5% to about 7% by weight.

18. A distillate of a roasted malt infusion obtainable by distilling the infusion of roasted malt in an aqueous solvent solution according to claim 6, wherein said distillate has a dry weight of from about 4.5% to about 7% by weight.

19. A method of preparing a beer or beer-like beverage, wherein the distillate according to claim 12 is added is after the step of yeast fermentation for providing said beer or beer-like beverage with additional body, base flavour and/or top notes.
